(19) United States
(12) Patent Application Publication
(10) Pub. No.: US 2022/0357731 A1
(43) Pub. Date: Nov. 10, 2022

(54) METHOD AND SYSTEM FOR INSPECTING USING MIXED REALITY ENVIRONMENT

(71) Applicants: Elizabeth M Lekarczyk, Fenton, MI (US); Doan R Whitt, White Lake, MI (US); Matthew A Chvojka, Oxford, MI (US); Keenan M O'Brien, Windsor (CA); Richard F Gunther, Walled Lake, MI (US); Jeffrey A Gandini, Armada, MI (US)

(72) Inventors: Elizabeth M Lekarczyk, Fenton, MI (US); Doan R Whitt, White Lake, MI (US); Matthew A Chvojka, Oxford, MI (US); Keenan M O'Brien, Windsor (CA); Richard F Gunther, Walled Lake, MI (US); Jeffrey A Gandini, Armada, MI (US)

(21) Appl. No.: 17/308,142

(22) Filed: May 5, 2021

(51) Int. Cl. G05B 23/02; G06T 19/00; G06F 3/0481; G02B 27/01

(52) U.S. Cl. CPC G05B 23/0216; G05B 23/0272; G06T 19/006; G06F 3/04815; G02B 27/017

(57) ABSTRACT

A test procedure system comprising a test component test procedure corresponding to test instructions, a computer model system comprising a test component computer model comprising inspection indicia therein, a head mounted display comprising an alignment system, aligning the test component within a field of view with the computer model to align the inspection indicia and a user interface associated with the head mounted display for entering test results.

### TECHNICAL FIELD

The present disclosure relates generally to inspecting assembled components within a mixed reality environment.

### BACKGROUND

The statements in this section merely provide background information related to the present disclosure and does not constitute prior art.

Inspecting components in a manufacturing environment is important for the overall quality of the assembled product. This is particularly important in manufacturing environments in which a large number of parts are assembled. One example of an assembled device is an automotive vehicle.

Within the vehicle manufacturing body shop, inspectors must analyze the quality of the body shop processes. A body shop includes many different types of processes such as welds that use an ultrasonic probe, robot programming of weld, stud and sealer locations and the like. Each of the different types of processes must correspond to a specific engineering design. Currently, inspectors refer to weld inspection books to monitor the position and quality of the various types of processes. The inspectors also use two dimensional drawings of parts, welds, studs and sealer locations. Weld inspection books and robot programming routines contain two dimensional drawings of parts, welds, studs and sealer locations. Weld inspection books and robot programming routines take a significant amount of power to create and often become outdated rather quickly. Inspectors may potentially conduct faulty inspections if the exact part, weld and sealer location are not located.

Laser projector three dimensional vision systems are sometimes used. However, these systems require stationary fixtures and thus the flexibility of the inspection and validation process is limited. Laser projectors require a significant amount of upfront programming. When the components change, a significant amount of rework is required for a laser projection system. Projection therefore cannot be continuously used because of the mobile environments of body shops. Curvature of parts makes it difficult for projecting weld, stud and sealer locations. Because of the inflexibility of a laser projector, such components are not desirable.

Reducing the amount of faulty inspections is important to improve the overall build quality of the vehicle.

### SUMMARY

The present disclosure provides methods and systems for inspecting manufactured components using an augmented reality environment.

In one aspect of the disclosure, a test procedure system comprising a test procedure corresponding to test instructions, a computer model system comprising a computer model comprising inspection indicia therein, a head mounted display comprising an alignment system, aligning a test component within a field of view with the computer model to align the inspection indicia and a user interface associated with the head mounted display for entering test results.

In a further aspect of the disclosure, a method of inspecting a test component includes communicating a test procedure having test instructions to an augmented reality device, communicating a computer model comprising a computer model having inspection indicia therein, aligning the test component within a field of view with the computer model to align the inspection indicia and entering test results into the augmented reality device.

Further areas of applicability of the teachings of the present disclosure will become apparent from the detailed description, claims and the drawings provided hereinafter, wherein like reference numerals refer to like features throughout the several views of the drawings.

### DRAWINGS

The drawings described herein are for illustration purposes only and are not intended to limit the scope of the present disclosure in any way.

FIG. 1 is a high level block diagram of a manufacturing system in accordance with the present disclosure.

FIG. 2 is a block diagram of an example of the inspection system in accordance with the present disclosure.

FIG. 3 is a screen view of the field of view augmented reality system without test indicia in accordance with the present disclosure.

FIG. 4 is a perspective view of the field of view of the augmented reality system with test indicia thereon.

FIG. 5 is a block diagram of an example of a wearable device in accordance with the present disclosure.

FIG. 6 is a perspective view of an augmented reality device on a user and illustrating linear and angular motion that is monitored by the virtual reality device.

FIG. 7 is a block diagram of an example of the augmented reality module of the virtual reality device of FIG. 6 in accordance with the present disclosure.

FIG. 8 is a block diagram of an example of a portion of a controller of the client device of FIG. 4 or the virtual reality device of FIG. 6 in accordance with the present disclosure.

FIG. 9 is a method of inspecting in accordance with the present disclosure.

### DETAILED DESCRIPTION

The teachings of the present disclosure can be implemented in a system for communicating content to an end user or user device (e.g., a mobile phone, a tablet, a computer, and/or a mixed reality device). Both the data source and the user device may include one or more modules having a memory or other data storage for incoming and outgoing data. For definitions and structure of the modules see below provided description and accompanying drawings.

The system includes one or more modules, processors, controllers, communication components, network interfaces or other associated circuitry that are programmed to allow communication with various other devices in a system.

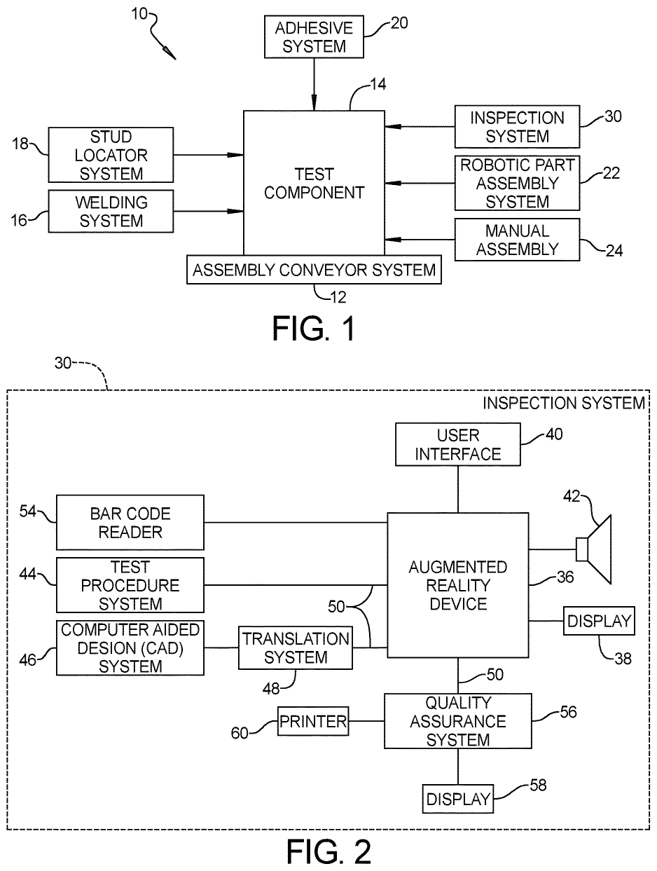

Referring now to FIG. 1, a manufacturing system 10 includes an assembly conveyor system 12 that moves components down the assembly line. In one example, the assembly conveyor system continually moves the test component 14 down the assembly line.

The test component 14 is an assembled or partially assembled assembly. In the following example, the test component 14 is a body portion of an automotive vehicle. The test component 14 is one which inspecting various aspects is desirable.

The test component 14 is processed by a number of different systems including at least one of a welding system 16, a study locator system 18, an adhesive system 20 and a robotic assembly system 22. The welding system 16 provides welds to secure components into predetermined locations. The stud locator system 18 locates studs for fastening other components to a main component. An adhesive system 20 provides adhesive in desired locations. The adhesive system provides a length or an amount of adhesive into the desired locations. The robotic part assembly system 22 assembles components into desired locations.

Manual assembly 24 is also used to secure other components together.

An inspection system 30 is used to inspect one or more test components 14 that have been processed by one or more of the systems 16 through 22 or the manual assembly 24.

Referring now to FIG. 2, the inspection system 30 is illustrated in further detail. The inspection system 30 has an augmented reality device 36 disposed therein. The augmented reality device 36 has a display 38 that is used to display items within the field of view of the augmented reality device 36 but also superimpose inspection indicia thereon as we described in more detailed below. The augmented reality device 36 also includes a user interface 40 that is used to input various types of data including measurements as will be described below. The user interface 40 includes one or more keyboard, touch screen, microphone or the like. A speaker 42 is used to provide audible cues to the users for feedback.

The augmented reality device 36 is in communication with a test procedure system 44. The test procedure system 44 provides a test procedure for inspecting components to the augmented reality device 36. The test procedure system 44 allows the operator of the augmented reality device 36 to process and perform an inspection procedure.

A computer-aided design system 46 is also in communication with the augmented reality device 36. The computer-aided design (CAD) system 46 has a computer model of the components to be inspected. The computer-aided design system 46 communicates a computer model to the translation system 48. The translation system 48 generates an augmented reality model that is suitable for use within the augmented reality device 36. The translation system 48 is a standalone system or a system that is included within the computer-aided design system 46 or the augmented reality device 36. The test procedure system 44 and the computer-aided design system 46, which includes the translation system 48, are in communication with the reality device through a network 50. The network 50 is one of a wired or wireless network.

A bar code reader 54 is in communication with an augmented reality device 36 in some examples. The bar code reader 54 scans a bar code on a test component to be inspected. The bar code reader 54 is used by the augmented reality device 36 to identify a component to be inspected. The augmented reality device 36, in some examples, is capable of automatically identifying the components to be tested based upon the computer-aided design system 46 and the computer models set forth therein.

As will be described in further detail below, the augment reality device queries the user for test data. In some examples, the test data includes an answer to a question such as whether a particular component exist. In other examples, the augmented reality device receives inputs such as measurements or the like according to the test procedures.

The augmented reality device 36 communicates test data to a quality assurance system 56. The quality assurance system 56 includes a display 58 and a printer 60. The quality assurance system 56 is in communication with the augmented reality device 36 through the network 50. The quality assurance system 56, in one example, compares the test data to the test procedure to determine whether the component that is tested is within specification. The quality assurance system 56, in another example, compares test data from multiple components to determine whether trends are occurring. Either the quality assurance system 56 or the augmented realized device 36 compares the test data to the test procedure to determine whether parts are within tolerance.

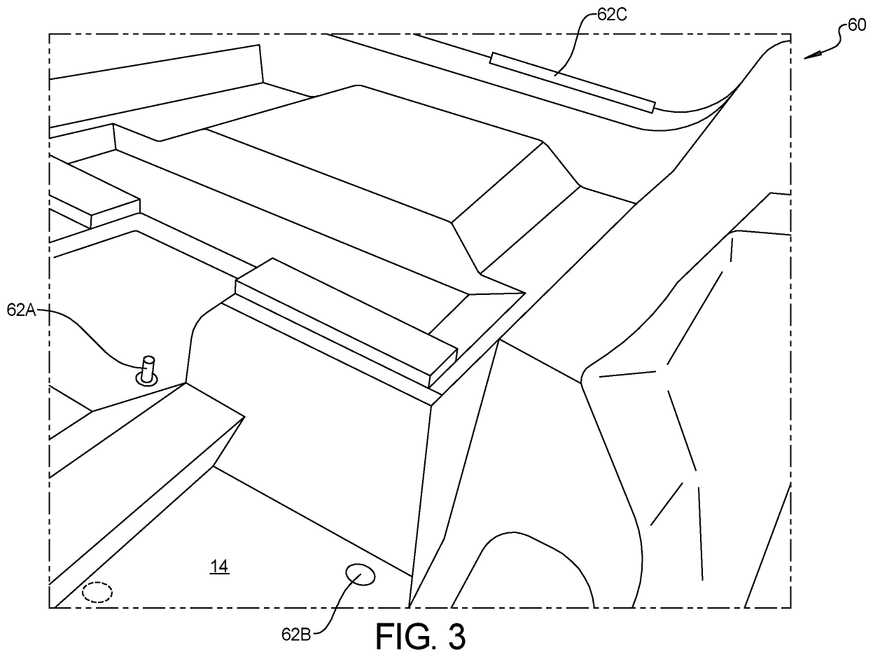

Referring now to FIG. 3, a field of view 60 from the augmented reality system 36 showing a test component 14 is illustrated within the field of view 60. The test component 14 includes a stud location 62A, a weld location 62B, and a sealer location 62C.

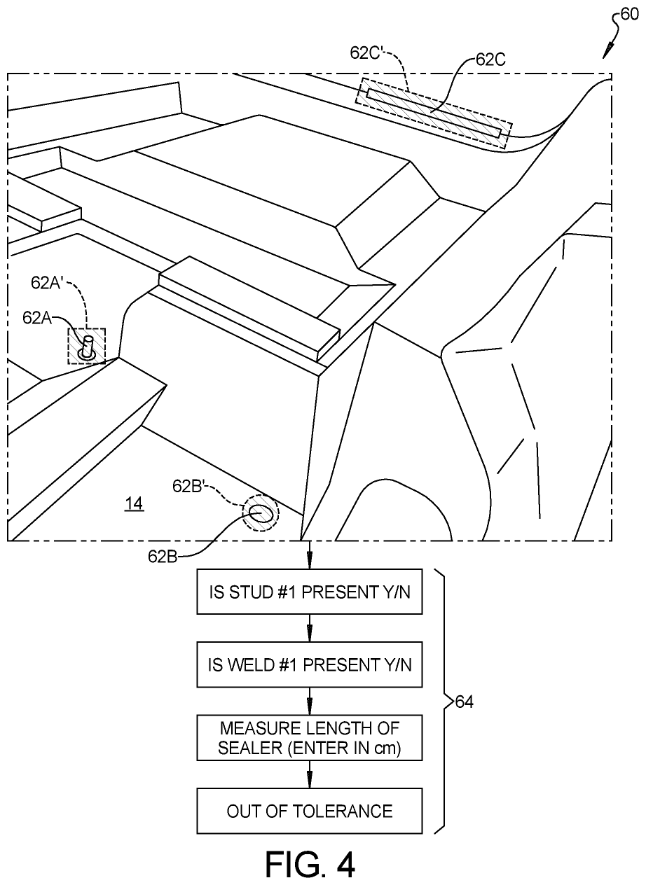

Referring now to FIG. 4, the field of view 60 of the test component is illustrated with test or inspection indicia 62 thereon. In this example, the test indicia 62 includes a stud location indicia 62A′, a weld location indicia 62B′, and a sealer indicia location 62C′. During a test procedure, the test or inspection indicia 62 is sequentially displayed after feedback from the operator wearing the augmented reality device 36. The test or inspection indicia 62A′-62C′ are highlight in the field of view of the user. The is shaped exactly as the part to be inspected but illuminated in a color such as green, or for simplicity of showing in two dimensional black and white drawings an area of the screen display. An instruction display area 64 is provided at the bottom of the field of view 60 to obtain a response from the system operator. Three examples of an instruction are provided at the bottom of the field of view 60 in the instruction display area 64 that prompt an input through a user interface from the user. An out of tolerance message is also displayed. In this example, the instruction display area 64 generates a question such as “is stud number 1 present”, “is weld number 1 present” and “measure the length of sealer”, each of the instructions displayed prompts a response from the operator. In this example, it is included for directing the operator to move into a particular position or move a movable component. The system, in this example, is used for instructing test components 14 on a moving assembly conveyor system 12. In other examples, parts are removed from a moving conveyor and inspected when stationary.

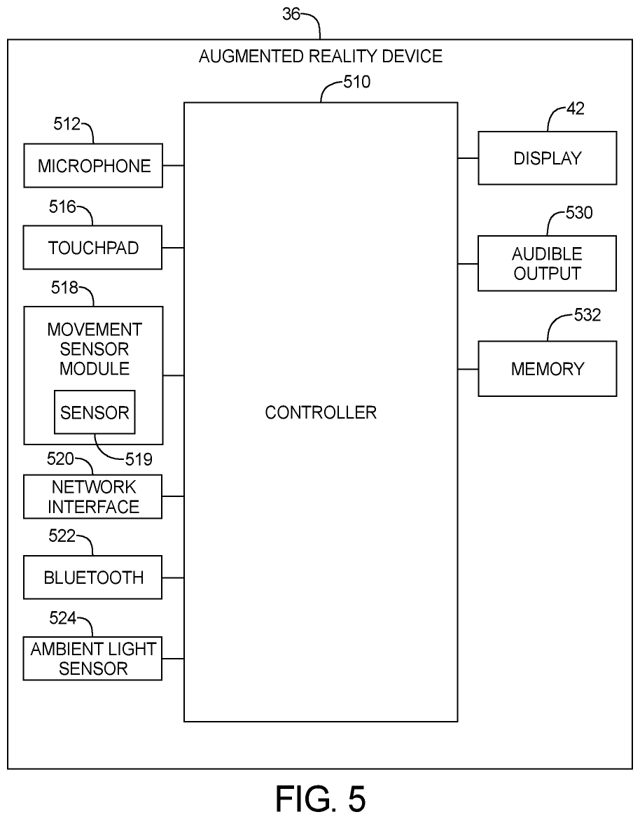

Referring now to FIG. 5, a block diagrammatic view of augmented reality device 36 is set forth. The augmented reality device 36 is used to provide locations and instructions superimposed on components or parts to be inspected in the field of view. The virtual reality device 36 includes a microphone 512 that receives audible signals and converts the audible signals into electrical signals. A touchpad 516 provides digital signals corresponding to the touch of a hand or finger. The touchpad 516 senses the movement of a finger or other user input. The augmented reality device 36 also includes a movement sensor module 518 that provides signals corresponding to movement of the device. Physical movement of the device also corresponds to an input. The movement sensor module 518 includes sensors 519, such as accelerometers, moment sensors, optical/eye motion detection sensors, and/or other sensors that generate signals allowing a device to determine relative movement and orientation of the device and/or movement of eye balls of a user (referred to as gaze tracking). The movement sensor module 518 also includes a magnetometer. Sensor data provided by the various sensors 519 is used to make selections. The touchpad 516 and the sensors 519 provide input and/or feedback from a user for the selection of offered/shown items and provide commands for changing a shown field of view (FOV).

The augmented reality device 36 also includes a network interface 520. The network interface 520 provides input and output signals to a wireless network, such as the internet. The network interface 520 also communicates with a cellular system.

A Bluetooth® module 522 sends and receives Bluetooth® formatted signals to and from the controller 510 and communicate the signals externally to the augmented reality device 36. Bluetooth® is one way to receive audio signals or video signals from the client device 34.

An ambient light sensor 524 generates a signal corresponding to the ambient light levels around the augmented reality device 36. The ambient light sensor 524 generates a digital signal that corresponds to the amount of ambient light around the augmented reality device 36 and adjusts the brightness level in response thereto.

The controller 510 communicates with the display 38, an audio output 530 and a memory 532. The audible output 530 generates an audible signal through a speaker or other device. Beeps and buzzers to provide the user with feedback is generated. The memory 532 is used to store various types of information including a user identifier, a user profile, a user location and user preferences. Of course, other operating parameters are stored within the memory 532 in other examples.

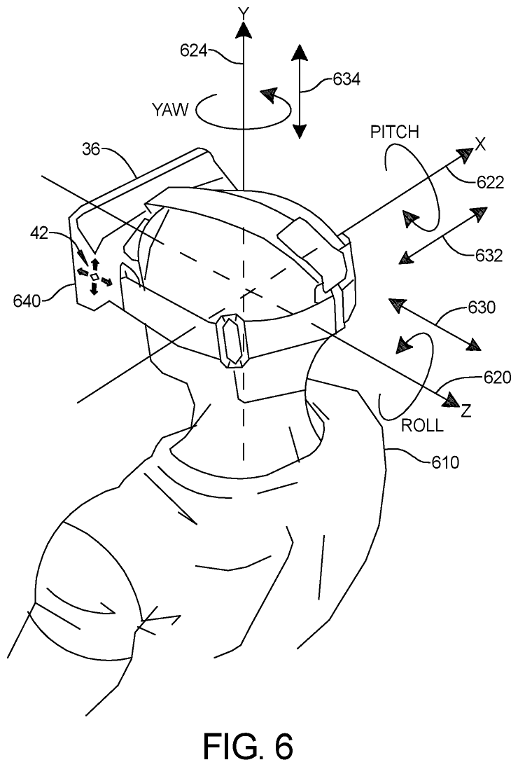

Referring now to FIG. 6, the movement sensors 518 of FIG. 5 is used to measure various perimeters of movement. A user 610 has the augmented reality device 36 coupled thereto. The moments around a roll axis 620, a pitch axis 622 and a yaw axis 624 are illustrated. Accelerations in the roll direction 630, the pitch direction 632 and the yaw direction 634 are measured by sensors within the augmented reality device 36. The sensors are incorporated into the movement sensor module 518, the output of which is communicated to the client device 34 for use within the augmented reality module 456. An example touchpad 638 is shown on a side of the augmented reality device 36.

The augmented reality device 36 is a head mounted display (HMD) that displays indicia for inspecting or locating components superimposed of the field of view of the device 36.

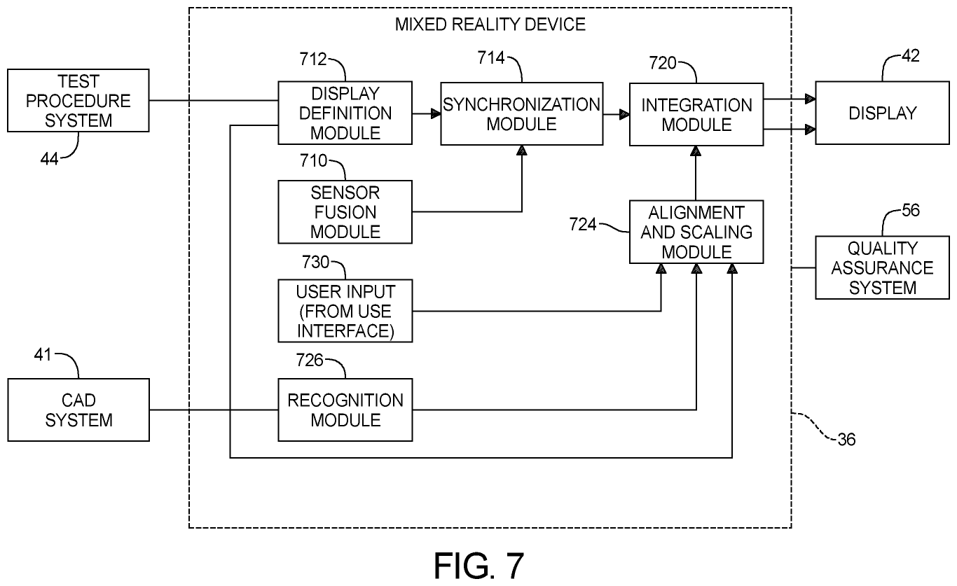

Referring now to FIG. 7, an example of the augmented reality module 456 is illustrated in further detail. The augmented reality module 456 include a sensor fusion module 710 that receives the sensor signals from the sensors 519, the touchpad 516, the microphone 512 of FIG. 5. The sensor fusion module 710 determines the ultimate movement of the augmented reality device 36 and/or eyeball movement to change indicia being displayed.

The augmented reality module 36 also include a display definition module 712. The display definition module 712 define a display area for displaying renderable signals with the displayed graphics of an application or program. The display definition module 712 receives signals from the test procedure system. For, example components to be measured are be outlined or highlighted by screen displayed inspection indicia.

The augmented reality system 36 disclosed herein change images and/or field of view angles displayed based upon the position of a head of a user, movement of the head (thus movement of the augmented reality device 36 of FIG. 1), audio command or request signals of the user, and/or eye movement of the user, as determined by the sensor fusion module 710. The movement of the head corresponds directly to the movement of the augmented reality device 36. The output of the display definition module 712 are input to a synchronization module 714. The synchronization module 714 coordinates the position of the component or part to be inspected with the display field of view with the output of the sensor fusion module 710. The synchronization module output 714 is communicated to an integration module 720.

The recognition module 726 recognizes the viewed component so that proper scaling and positioning of the instructions or inspection indicia are located relative to the viewed component in the field of view of the augmented reality device 36.

The integration module 720 also receive an output from an alignment and scaling module (system) 724. The indicia signals are communicated to the scaling module 724 to be properly scaled for the size and perspective of a display area of graphics generated by the augmented reality device 36. The integration module 720 outputs rendered signals corresponding to the application and the live television signals that have been scaled to the display 38. This includes sending audio content to one or more speakers of: the augmented reality device 36; and/or the client device 34 if the client device 34 is being used as part of the augmented reality device 36.

A user input 730 from a user interface such as a game controller or a touch screen is used to change the screen display. For example, the video changes from the display area graphics to a full screen upon command from the user. A button or voice command signal is generated to perform this function.

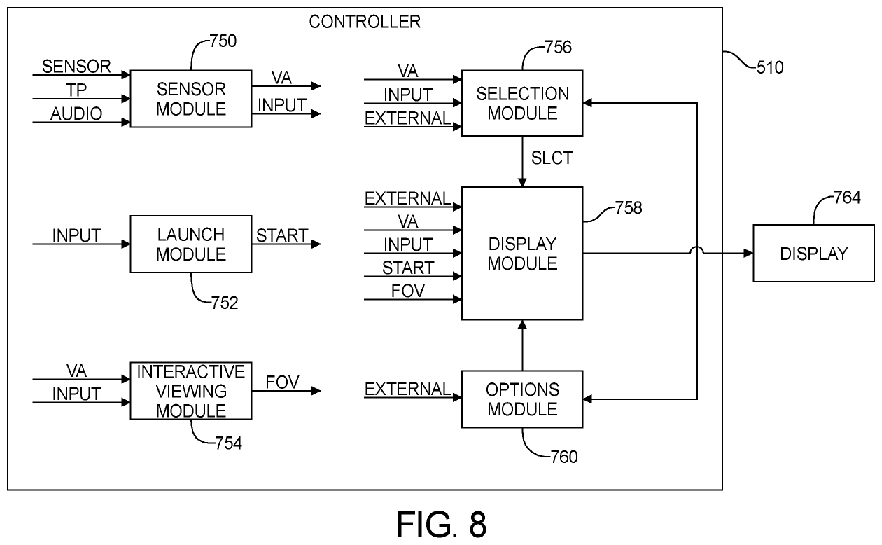

Referring now to FIG. 8, an example of a portion of the controller (or control module) 510 is set forth. The controller 510 further includes a sensor module 750, a launch module 752, an interactive viewing module 754, a selection module 756, a display module 758, an options module 760, an upgrade module 762, and a scoreguide module 764. The sensor module 750 includes the sensor fusion module 710 of FIG. 7 and receive sensor signals SENSOR from the sensors 519 of FIG. 5, audio signals AUDIO from microphones 412, 512 of FIG. 5, and/or a signal TP from an input device (e.g., a device having buttons and/or a touch pad) on an augmented reality device (e.g., one of the augmented reality devices disclosed herein). The sensor module 750 generates a viewing angle signal VA and/or a sensor input signal INPUT. The viewing angle signal VA indicates: linear and/or angular motion and/or position of a augmented reality device (the augmented reality device 36 of FIG. 2 or other augmented reality device); motion and/or position of user eye balls; a requested viewing angle; an amount of time the augmented reality device 36 and/or user eye balls are located in particular positions; angular position information; displacement from a previous position; and/or other position indicative information indicating position, angles and/or orientation of the augmented reality device and/or eye balls in 3D space. The input signal INPUT is generated based on the signal TP and indicate, for example, buttons pressed by a user, length of time the buttons are pressed, and/or other input information.

The launch module 752 launches an App (i.e. starts execution of a selected App such as an inspection application). This is based on and/or in response to one or more of the signals VA, INPUT and/or the information included in the signals VA, INPUT. The launch module 752 generates a signal START indicating that the App is started and/or video content to be displayed on the display 764.

The interactive viewing module 754 generates a field-of-view signal FOV indicating a FOV based on one or more of the signals VA, INPUT and/or the information included in the signals VA, INPUT. The FOV includes and/or be a portion of an augmented reality environment and is displayed on the display 764 (e.g., one of the displays). The augmented reality environment is viewed at various locations where components or parts are to be inspected.

As a user's head and/or eye balls move, the FOV changes. The FOV is adjusted and therefore the relocation the indicia and instructions is changed. The images of the indicia are forwarded to the augmented reality device 36 prior to receiving updated versions of the signals VA, INPUT to provide quick response time in viewing the FOV on the display 764.

The selection module 756 is used to implement selections by a user. The selection module 756 selects viewing parameters, an App, component locations, points of reference, etc. The selection module 756 generates a selection signal SLCT indicating the selections based on one or more of the signals VA, INPUT. The selection module 756 monitors the signal INPUT and/or movement of the HMD, augmented reality device, and/or eye balls and/or the signals from the microphones, 512 to determine whether the user has made a certain selection. For example, if the user's head moves, a cursor displayed on the display 764 is moved from one tile or chicklet to another tile or chicklet to select a certain selection, component, App, etc. The various items that is selected is highlighted, circled, and/or are identified in some other manner as the user's head and/or eye balls move to allow the user to make the appropriate selection. In one embodiment, when the user stops on one of the selectable items for a predetermined period of time that item is selected.

The display module 758 controls display of the augmented reality environment and other video content on the display 764. This is based on: one or more of the signals VA, INPUT, START, SLCT, FOV from the modules 750, 752, 754, 756; signals received from the modules 760, 762; and/or signals EXTERNAL. The signal EXTERNAL includes signals with video and/or audio content, measurement, statistics, menu data, etc. The signal EXTERNAL and/or content and information provided in the signal EXTERNAL is provided to any of the modules of the controller 510 and based on which the modules performs corresponding tasks. A user moves the augmented reality device, eyeballs, and/or command viewing of an area to the left, right, up, and/or down relative to point in a center of a current FOV.

The options module 760 generates display content for various different options that is displayed on the display 764 and selected by a user, as is indicated by the selection signal SLCT. The options includes different components to be inspected or different test procedures to be carried.

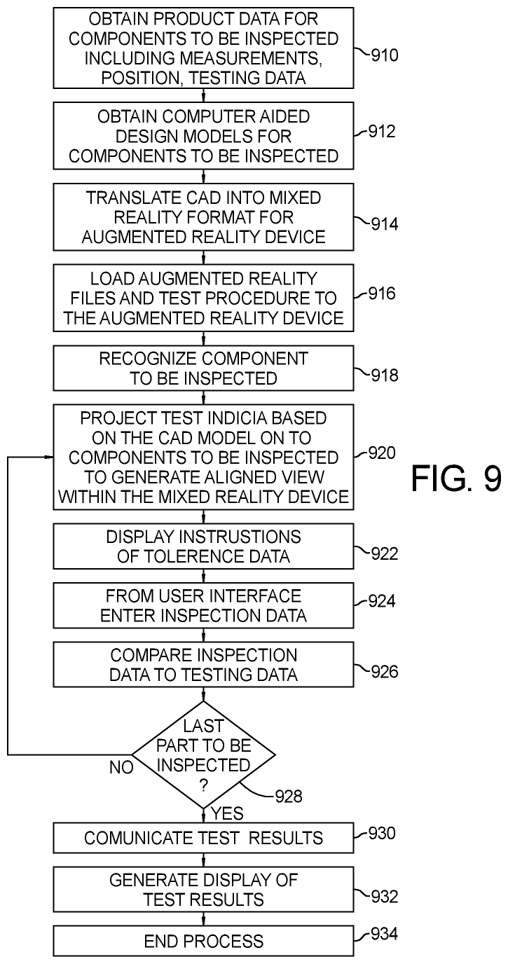

Referring now to FIG. 9, a method of operating the inspection system is set forth. In step 910, product data is obtained for the component to be inspected including test data such as measurements and positions. In this example, the test procedure system 44 provides the measurements and positions. However, in other examples, the computer-aided design system 46 provides the actual measurement while the test procedure itself is provided from the test procedure system 44.

In step 912, the computer-aided design models for the components to be inspected are provided from the computer-aided design system 46.

In step 914, the computer-aided design models are translated into a mixed reality format for the augmented reality device.

In step 916, the augmented reality files in the test procedure are communicated to the augmented reality device through a network. The network is a wired or wireless connection as described above. In step 918, the augmented reality device recognizes the component to be inspected. The recognition of the component in one examples uses a bar code that is provided on the test component or a test component carrier itself. In other examples, the component to be inspected is automatically recognized using the computer-aided design and translated augmented reality file. Edges of the test component are recognized which are in the field of view of the augmented reality device.

In step 920, the virtual reality CAD model and the test indicia based on the CAD model are projected onto the components to be inspected to generate an aligned view within the mixed reality device as is set forth in FIG. 4. As mentioned above, the test indicia are sequentially projected to perform the test procedure. In other examples, all of the test indicia or most of the test indicia are displayed. In step 922, the instructions or tolerance data is displayed on the augment reality display. In step 924, the user interface is of the augmented reality devices used for entering inspection data. As mentioned above, the inspection data is an affirmative answer to an inspection query in one example. In another example, a measurement, such as the measurement for the length of sealer, is entered. In step 926, the inspection data is compared to the testing data entered at the user interface. In step 928, the determination of the last part or component to be inspected. When the last part or component, such as a weld stud or sealer, is not provided, steps 920-926 are repeated until the end of the test procedure is achieved. In step 928, when the end of the test procedure is achieved, step 930 communicates the test results to the quality assurance system 56. The communication of the test data is an optional feature. In step 932, a display of the test results is provided. The test results are displayed in the display of the augmented reality device or on the display of a quality assurance system 56. In step 934, the process ends.

The wireless communications described in the present disclosure can be conducted in full or partial compliance with IEEE standards, such as IEEE standard 802.11-2012, IEEE standard 802.16-2009, IEEE standard 802.20-2008 and/or other suitable IEEE standards. In various implementations, IEEE 802.11-2012 is supplemented by draft IEEE standard 802.11ac, draft IEEE standard 802.11ad, and/or draft IEEE standard 802.11ah.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method is executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term “module” or the term “controller” is replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip. Each module may include and/or be implemented as a computing device, which is implemented in analog circuitry and/or digital circuitry. Further, the computing device may include a microprocessor or microcontroller that performs instructions to carry out steps performed by various system components.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure is distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc). The computer-readable medium and/or memory disclosed herein may include, for example, a hard drive, Flash memory, radon access memory (RAM), programmable read only memory (PROM), electrically erasable programmable read only memory (EEPROM), read only memory (ROM) phase-change memory and/or other discrete memory components.

In this application, apparatus elements described as having particular attributes or performing particular operations are specifically configured to have those particular attributes and perform those particular operations. Specifically, a description of an element to perform an action means that the element is configured to perform the action. The configuration of an element includes providing the hardware and optionally the software to perform the corresponding action in addition to the hardware provided. Examples of the structure that is used to perform the corresponding action are provided throughout the specification and illustrated by the provided drawings. See the examples of the defined structure disclosed by the modules, devices, elements and corresponding methods described herein. The configuration of an element may include programming of the element, such as by encoding instructions on a non-transitory, tangible computer-readable medium associated with the element.

The apparatuses and methods described in this application is partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code is written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A manufacturing inspection system for inspecting a test component comprising:
a test procedure system comprising a test component test procedure having test instructions;
a computer model system comprising a test component computer model comprising inspection indicia therein;
a head mounted display comprising an alignment system, aligning the test component within a field of view with the computer model to align the inspection indicia; and
a user interface associated with the head mounted display for entering test results.

2. The inspection system of claim 1 wherein the head mounted display displays inspection indicia and test instructions.

3. The inspection system of claim 1 wherein the head mounted display displays inspection indicia and test instructions sequentially until the test procedure is complete.

4. The inspection system of claim 1 wherein the test component is disposed on an assembly conveyor system.

5. The inspection system of claim 1 wherein the test component comprises a weld, a stud or adhesive.

6. The inspection system of claim 5 wherein the inspection indicia corresponds to a weld position of the weld, a stud position of the stud or an adhesive length of the adhesive.

7. The inspection system of claim 1 further comprising a translation system for converting the computer model to an augmented reality model.

8. The inspection system of claim 7 wherein the translation system is disposed within the head mounted display unit.

9. The inspection system of claim 1 further comprising a quality assurance system in communication with the head mounted display for receiving the test results.

10. The inspection system of claim 1 wherein the head mounted display compares test data to the test results and generates a display in response thereto.

11. The inspection system of claim 1 wherein the head mounted display comprises an augmented reality device.

12. A method of inspecting a test component comprising:
communicating a test procedure having test component test instructions to an augmented reality device;
communicating a computer model comprising a test component computer model having inspection indicia therein;
aligning the test component within a field of view with the computer model to align the inspection indicia; and
entering test results into the augmented reality device.

13. The method of claim 12 further comprising displaying inspection indicia and test instructions.

14. The method of claim 12 further comprising displaying inspection indicia and test instructions sequentially until the test procedure is complete.

15. The method of claim 12 further comprising moving the test component on an assembly conveyor system.

16. The method of claim 12 wherein the test component comprises a weld, a stud or adhesive and wherein the inspection indicia corresponds to the weld, stud or adhesive.

17. The method of claim 12 further comprising converting the computer model to an augmented reality model in a translation system.

18. The method of claim 17 wherein the translation system is disposed within the augmented reality device.

19. The method of claim 12 further comprising communicating the test results to a quality assurance system in communication with the augmented reality device.

20. The method of claim 12 wherein the augmented reality device compares test data to the test results and generates a display in response thereto.
